(19) United States
(12) Patent Application Publication
(10) Pub. No.: US 2026/0142512 A1
(43) Pub. Date: May 21, 2026

(54) MOTOR CORE

(71) Applicant: NHK SPRING CO., LTD., Yokohama-shi (JP)

(72) Inventors: Hisaaki TESHIMA, Yokohama-shi (JP); Shuji TAKAHASHI, Yokohama-shi (JP)

(21) Appl. No.: 19/388,309

(22) Filed: Nov. 13, 2025

(30) Foreign Application Priority Data
Nov. 21, 2024 (CN) 202411669565.9

(51) Int. Cl. H02K 1/276

(52) U.S. Cl. CPC H02K 1/276

(57) ABSTRACT

A motor core includes: a motor core main body having plural slots arranged circularly at predetermined intervals; plural magnets that are inserted into the plural slots; a pressing body that supports, from at least one of end portions of the plural slots in a direction along a central axis of the motor core main body, the plural magnets inserted into plural slots; and holding plates attached to both end portions of the motor core main body along the central axis. The pressing body includes a spring member having an annular shape or a C shape in plan view in which valley portions uplifted in a direction toward the motor core main body and peak portions uplifted in a direction away from the motor core main body are alternately provided along a circumference around the central axis of the motor core main body.

### CROSS-REFERENCE TO RELATED APPLICATION

This application is based on and claims priority under 35 USC 119 from Chinese Patent Application No. 202411669565.9 filed on November 21, 2024, the disclosure of which is incorporated by reference herein.

### BACKGROUND

### Technical Field

The technology of the present disclosure relates to a motor core.

### Related Art

Some rotating electrical machines have a motor core, such as a rotor core, to which a permanent magnet is attached. As described above, as one of methods of attaching the permanent magnet to the motor core, a method is known in which the permanent magnet is inserted into a slot provided in the motor core, and then a resin composition is filled around the permanent magnet and cured.

Japanese Patent Application Laid-Open (JA-P) No. 2013-009453 describes that a resin tablet having a predetermined size is softened and melted by being heated in a pot, and then a resin composition is filled into a slot of a rotor core and cured, whereby a magnet is fixed.

### SUMMARY

According to the method disclosed in JP-A No. 2013-009453, the magnet can be stably fixed in the slot. However, a dedicated manufacturing device is required to perform a series of operations of softening and melting the resin and filling the resin into the slot. Hence, there is a demand for a motor core enabling a magnet to be assembled in a slot more easily and stably than in such a method.

The disclosure provides a motor core enabling a magnet to be supported in a slot in a simple configuration.

A motor core according to a first aspect of the disclosure includes: a motor core main body having a plurality of slots arranged circularly at predetermined intervals; a plurality of magnets that are inserted into the plurality of slots; a pressing body that supports, from at least one of end portions of the plurality of slots in a direction along a central axis of the motor core main body, the plurality of magnets inserted into the plurality of slots; and holding plates attached to both end portions of the motor core main body along the central axis. The pressing body includes a spring member having an annular shape or a C shape in plan view in which valley portions uplifted in a direction toward the motor core main body and peak portions uplifted in a direction away from the motor core main body are alternately provided along a circumference around the central axis of the motor core main body, and at least one of the valley portions abuts on an end portion of each of the plurality of magnets when the pressing body is installed on at least one of the end portions of the motor core main body in the direction along the central axis.

In the motor core as described above, the magnets can be assembled in the slots in a simple configuration by using the pressing body.

Regarding the motor core according to a second aspect of the disclosure, in the motor core according to the first aspect of the disclosure, at least one of a surface of the holding plate on a side adjacent to the motor core main body or a surface of the motor core main body with which the pressing body is brought into contact has an accommodation portion capable of accommodating the pressing body.

In the motor core as described above, the pressing body is not exposed outside, and an assembly state of the magnet is stabilized.

Regarding a third aspect of the disclosure, in the motor core according to the first or second aspect of the disclosure, lengths of the plurality of magnets in the direction along the central axis in a case of being inserted into the plurality of slots are shorter than lengths of the plurality of slots in the direction along the central axis.

In the motor core as described above, all of the magnets are accommodated in the slots, and assembly of the motor core is easily performed.

Regarding the motor core according to a fourth aspect of the disclosure, in the motor core according to any one of the first to third aspects of the disclosure, the pressing body includes a plurality of the spring members adjusted to have different diameters.

In the motor core as described above, the plurality of the spring members are provided, whereby assembly of the magnets can be stably performed regardless of a layout of the slots.

Regarding the motor core according to a fifth aspect of the disclosure, in the motor core according to any one of the first to fourth aspects of the disclosure, at least one of the holding plate or the motor core main body includes a positioning portion that positions the pressing body.

In the motor core as described above, it is easy to adjust the position of the pressing body with respect to the magnets or the like.

Regarding the motor core according to a sixth aspect of the disclosure, in the motor core according to any one of the first to fifth aspects of the disclosure, all the valley portions abut on the plurality of magnets accommodated in the plurality of slots.

In the motor core as described above, the assembly state of the magnet is stabilized.

According to the motor core of the disclosure, the magnets can be supported in the slots in the simple configuration.

### BRIEF DESCRIPTION OF THE DRAWINGS

Exemplary embodiments of the present invention will be described in detail based on the following figures, wherein:

FIG. 1 is an exploded perspective view illustrating an example of a motor core according to an embodiment;

FIG. 2 is an enlarged view of one end portion of the motor core illustrated in FIG. 1;

FIG. 3 is a cross-sectional view of the assembled motor core taken along line A-A in FIG. 2;

FIG. 4 is an enlarged view of a B portion in FIG. 3;

FIG. 5 is a cross-sectional view of a motor core according to a modification example, the view corresponding to FIG. 3;

FIG. 6 is a cross-sectional view of a motor core according to another modification example, the view corresponding to FIG. 3; and

FIG. 7 is a plan view obtained by omitting a holding plate of a motor core according to still another modification example.

### DETAILED DESCRIPTION

The present disclosure will become more fully understood from the detailed description given hereinbelow. Further range of application of the present disclosure will become clearer from the detailed description given hereinbelow. However, the detailed description and the specific embodiment are illustrated of desired embodiments of the present disclosure and are described only for the purpose of explanation. Various changes and modifications will be apparent to those ordinary skilled in the art on the basis of the detailed description.

The applicant has no intention to give to public any disclosed embodiment. Among the disclosed changes and modifications, those which may not literally fall within the scope of the patent claims constitute, therefore, a part of the present invention in the sense of doctrine of equivalents.

Like reference numbers and designations in the various drawings indicate like elements.

Hereinafter, embodiments for carrying out the disclosure will be described with reference to the drawings. In the following description, a range necessary for the description in order to achieve the object of the disclosure will be schematically described, a range necessary for a description of a corresponding portion of the disclosure will be mainly described, and a portion for which a description is omitted will be based on known technologies. Members that are the same as or correspond to each other in the drawings are denoted by the same or similar reference numerals, and redundant descriptions thereof are omitted. In a case in which a plurality of members identical or corresponding to each other in the drawings are included, only some of the members may be denoted by reference numerals in order to make the drawings easy to see.

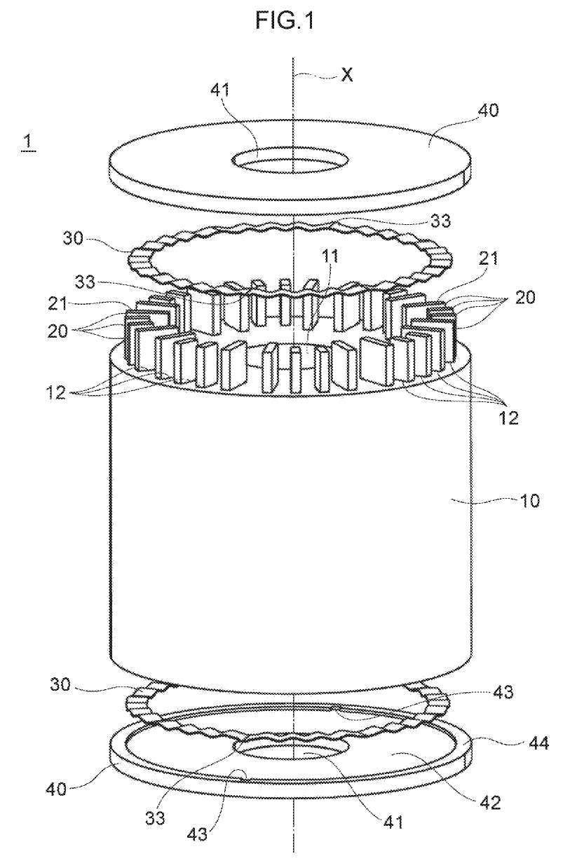

FIG. 1 is an exploded perspective view illustrating an example of a motor core according to an embodiment of the disclosure. A motor core 1 according to the embodiment may be one component of a motor to which magnets are attached, and can be, for example, a rotor core included in an inner rotor type motor as illustrated in FIG. 1.

The motor core 1 according to the embodiment includes at least a motor core main body 10 having a plurality of slots 12 arranged circularly at predetermined intervals, a plurality of magnets 20 that are inserted into the plurality of slots 12, a pressing body 30 that supports the plurality of magnets 20 inserted into the plurality of slots 12, and holding plates 40 that are attached to both end portions of the motor core main body 10 along a central axis thereof.

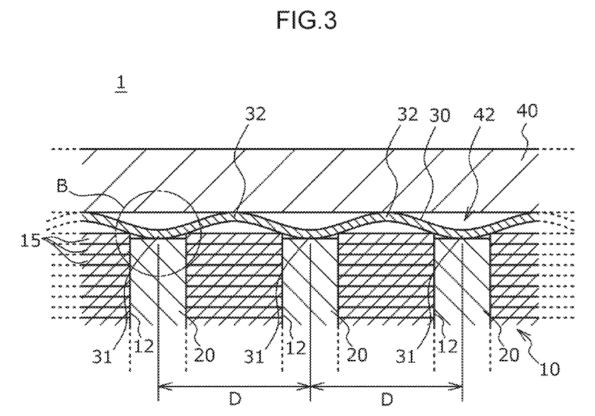

The motor core main body 10 can include a substantially cylindrical magnetic body formed by layering a plurality of core pieces 15 (see FIG. 3) made of relatively thin electromagnetic steel sheets. The number of the core pieces 15 included in the motor core main body 10 is not particularly limited, and can be about from 50 to 400, for example. A thickness of the core piece 15 may be, for example, from 0.05 to 2.00 mm. The plurality of core pieces 15 may be only simply layered on each other, caulked and bonded by a caulking portion (not illustrated) formed in each of the core pieces 15, bonded by applying an adhesive between the core pieces 15, or at least partially welded.

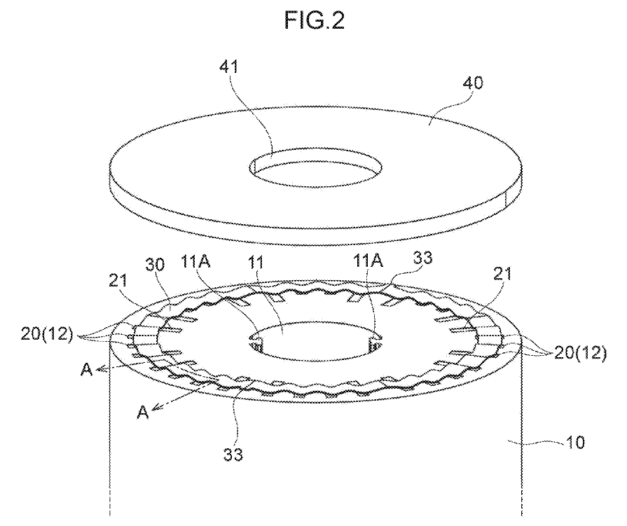

A through-hole 11 into which a shaft (not illustrated) forming a rotation shaft when assembled as a motor is inserted may be provided at an axial center portion of the motor core main body 10. One or a plurality of (two in FIG. 2) ridges 11A which are to support the above-described shaft may be provided inside the through-hole 11.

In the motor core main body 10, the plurality of (in FIG. 1, 32) slots 12 extending along a central axis X of the motor core main body 10 are arranged circularly at predetermined intervals to surround the through-hole 11. The slot 12 can include a through-hole having a shape into which the magnet 20 can be inserted, such as a rectangular parallelepiped shape penetrating the motor core main body 10 along the central axis X or an arc shape in plan view, and a specific shape and arrangement thereof are not particularly limited. Similarly, the number of slots 12 can be arbitrarily changed, and may be more or less than 32 illustrated in FIG. 1.

The slots 12 of the embodiment are exemplified by slots which include through-holes with openings having a rectangular shape extending radially around the central axis X and have circumferential intervals set at equal intervals. In addition, the slots 12 of the embodiment include a slot with the above-described rectangular opening having a different longitudinal length. A layout including an extension direction and arrangement of the individual slots 12 in plan view is not limited to the layout described above, and can be changed regarding a direction, strength, or the like of magnetic fields generated around the magnets 20, if appropriate.

The magnet 20 can include a permanent magnet, and is inserted into and supported in the slot 12 of the motor core main body 10. The magnet 20 can include, for example, a rectangular parallelepiped body slightly smaller than the slot 12 or a block body having an arc shape in plan view. It does not matter whether or not the magnet 20 is magnetized at the time of being inserted into the slot 12. The magnet 20 may be divided in a direction along the central axis X or a direction orthogonal to the direction along the central axis X. FIG. 1 illustrates a state in which the magnet 20 is partially inserted into the slot 12.

The pressing body 30 includes a spring member having an annular shape or a C shape in plan view in which valley portions 31 uplifted in a direction toward the motor core main body 10 and peak portions 32 uplifted in a direction away from the motor core main body 10 are alternately provided along a circumference around the central axis X. In the embodiment, as the pressing body 30, a substantially toric wave spring which includes a belt-shaped metal plate and is formed such that ridge lines of the valley portions 31 and the peak portions 32 radially extend around the central axis X is employed. A layout of the valley portions 31 and the peak portions 32 of the pressing body 30 and an extension direction of the ridge lines thereof are changed, if appropriate, depending on the arrangement or the extension direction of the slots 12 of the motor core main body 10. Hence, for example, the disclosure can also include a configuration in which the valley portions 31 and the peak portions 32 are not radially formed around the central axis X.

It is preferable that the valley portion 31 of the above-described pressing body 30 is curved in an arc shape when viewed from a side. As described above, when the valley portion 31 is curved in the arc shape, a contact point 50 can be substantially brought into surface contact with the magnet 20 at the time of abutting on the magnet 20. Therefore, a support structure having high abrasion resistance can be obtained. The shape of the valley portion 31 is not limited to the above-described arc shape, and may be, for example, a bent shape when viewed from the side, a shape having a flat surface extending along an end surface 21 of the magnet 20, or the like.

FIG. 2 is an enlarged view of one end portion of the motor core illustrated in FIG. 1. FIG. 2 illustrates a state in which the magnets 20 and the pressing body 30 are set at assembled positions with respect to the motor core main body 10 from the state in which each component is disassembled as illustrated in FIG. 1. The pressing body 30 is installed on at least one of the end portions of the motor core main body 10 in the direction along the central axis X. As illustrated in FIG. 1, the pressing bodies 30 of the embodiment are installed at both the end portions of the motor core main body 10 in one-to-one correspondence. The pressing body 30 installed at the one end portion in the direction along the central axis X of the motor core main body 10 has the valley portions 31 that abut on the respective end surfaces 21 of the plurality of magnets 20 as illustrated in FIG. 2. In this regard, the layout of the valley portions 31 of the pressing body 30 of the embodiment and installation positions of the pressing body 30 with respect to the motor core main body 10 are adjusted in advance. Details of the support structure of the pressing body 30 for the magnets 20 will be described below.

The holding plates 40 are installed at both the end portions of the motor core main body 10 in the direction along the central axis X in one-to-one correspondence and fix the motor core main body 10 and the pressing bodies 30. The holding plate 40 can include a disk-shaped member which is made of a metal such as aluminum, steel, or the like, has an outer diameter substantially equal to that of the motor core main body 10, and has a communication hole 41 communicating with the through-hole 11 of the motor core main body 10 which is formed at a substantially central portion of the holding plate. The holding plate 40 can be fixed to the motor core main body 10 and the pressing body 30, for example, by fixing an outer edge portion 44 of the holding plate 40 to the motor core main body 10 with an adhesive or the like or by fixing the outer edge portion 44 to a shaft inserted into the through-hole 11, but a specific fixing structure is not limited thereto.

A surface of the holding plate 40 of the embodiment which is adjacent to the motor core main body 10, in other words, a surface facing the end portion of the motor core main body 10, preferably has an accommodation recess portion 42 as an example of an accommodation portion capable of accommodating the pressing body 30. In the embodiment, a case in which the holding plate 40 has the accommodation recess portion 42 is exemplified, but instead of or in addition to the accommodation recess portion 42, an accommodation portion in which at least a part of the pressing body 30 is accommodated may be provided in a surface of the motor core main body 10 with which the pressing body 30 comes into contact. In a case in which the pressing body 30 is arranged only on one end surface of the motor core main body 10, the above-described accommodation recess portion 42 may be provided only in one holding plate 40 of the two holding plates 40, and a surface of the other holding plate 40 which faces the motor core main body 10 may be formed as a substantially flat surface to close one opening of the slot 12.

At least one of the holding plate 40 or the motor core main body 10 preferably has a positioning portion that positions the pressing body 30. In the embodiment, as illustrated in FIG. 1, a case in which positioning grooves 43 as an example of the positioning portions are provided at one or a plurality of locations (two locations in FIG. 1) in a side wall surface of the accommodation recess portion 42 is exemplified. The positioning grooves 43 accommodate positioning protrusions 33 provided at an outer circumferential portion of the pressing body 30 when the pressing body 30 is assembled. When the positioning protrusions 33 are accommodated in the positioning grooves 43, the pressing body 30 can be positioned with respect to the holding plate 40, particularly, in a rotation direction around the central axis X. The valley portions 31 and the magnets 20 are easily positioned by providing the above-described positioning grooves 43.

The configuration of the positioning portion is not limited to that described above, and can be changed, as appropriate, as long as the pressing body 30 can be positioned. The arrangement, the shape, or the number thereof can be adjusted, as appropriate. Specifically, an example of the configuration includes a structure in which an accommodation recess portion formed in the holding plate 40 is formed in a toric shape conforming to the shape of the pressing body 30, one or a plurality of positioning grooves are formed in a wall surface on an inner circumferential side and/or an outer circumferential side of the toric accommodation recess portion, and positioning protrusions are provided at corresponding positions on an inner circumferential side and/or an outer circumferential side of the pressing body 30.

The motor core 1 according to the embodiment can support the magnets 20 in the slots 12 of the motor core main body 10 by employing the above-described configuration, particularly, the configuration related to the pressing body 30, without performing the resin molding exemplified in the related art. Hereinafter, a support structure of the configuration will be described in more detail.

FIG. 3 is a cross-sectional view of the assembled motor core taken along line A-A in FIG. 2. When the motor core 1 is assembled, the pressing body 30 is accommodated in the accommodation recess portion 42 to be sandwiched between the motor core main body 10 and the holding plate 40 as illustrated in FIG. 3. At this time, arrangement and a size of the valley portions 31 formed in the pressing body 30 are adjusted in advance depending on arrangement or the like of the slots 12, and a position of the pressing body 30 with respect to the motor core main body 10 is adjusted by the positioning grooves 43 and the positioning protrusions 33. Specifically, in the embodiment, a case is exemplified in which the number of the valley portions 31 is equal to the number of the slots 12, and the positions of the valley portions 31 are adjusted so that every valley portion 31 abuts on any of the plurality of magnets 20.

In the assembled motor core 1, as illustrated in FIG. 3, the above-described adjustment makes the valley portions 31 of the pressing body 30 abut on the end surfaces 21 of the magnets 20 in the direction along the central axis X in one-to-one correspondence. A part of the valley portion 31 of the pressing body 30 at this time enters the slot 12. The peak portion 32 formed between the adjacent valley portions 31 abuts on a bottom surface of the accommodation recess portion 42 of the holding plate 40. This enables the valley portions 31 to stably support the magnets 20 without being separated from the end surfaces 21 even in a case in which an external force acts on the pressing body 30 during motor rotation or the like.

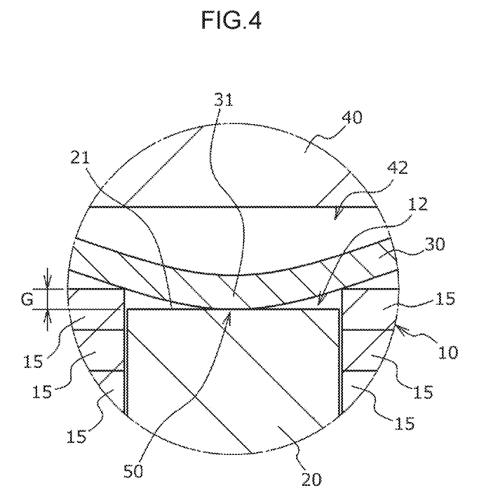

FIG. 4 is an enlarged view of a B portion in FIG. 3. The valley portion 31 which abuts on the end surface 21 of the magnet 20 is curved in an arc shape as illustrated in FIG. 4. The end surface 21 of the magnet 20 is formed as a substantially flat surface. Therefore, the contact point 50 between the end surface 21 and the valley portion 31 is brought into surface contact by causing a front surface of the valley portion 31 to be slightly crushed. As described above, when the contact point 50 is brought into surface contact, a relatively large contact area is secured, thereby enabling local abrasion of the valley portion 31 or the magnet 20 to be reduced. In the embodiment, a case in which the end surface 21 is formed as a substantially flat surface is exemplified, but the end surface 21 may be uneven.

Incidentally, when a length of the magnet 20 in the direction along the central axis X is equal to a length of the motor core main body 10, in other words, the slot 12, in the direction along the central axis X, the magnet 20 is less likely to move inside the slot 12, and this is preferable. However, it may be difficult to make the above-described two lengths equal to each other due to a slight variation in the thickness of the core piece 15 or the like. When, for example, the length of the magnet 20 in the direction along the central axis X becomes longer than the length of the motor core main body 10 in the direction along the central axis X due to the above-described variation, the magnet 20 projects from an opening portion of the slot 12, and in some cases, it becomes difficult to fix the magnet by the holding plate 40.

In the embodiment, the length of the magnet 20 in the direction along the central axis X is set to be shorter than the length of the motor core main body 10 in the direction along the central axis X. With this setting, the position of the end surface 21 of the magnet 20 in a state in which the magnet 20 is accommodated in the slot 12 is located inside the slot 12 by a length G (for example, a length equal to or shorter than the thickness of one of the core pieces 15) from the end surface position of the motor core main body 10. However, since the pressing body 30 of the embodiment comes into contact with the end surface 21 of the magnet 20 with a part of the valley portion 31 entering the slot 12 as described above, the contact point 50 can be stably formed even when the length of the magnet 20 in the direction along the central axis X is shorter than the length of the motor core main body 10 in the direction along the central axis X. Since the pressing body 30 includes an annular or C-shaped spring member, the plurality of magnets 20 can be supported by the one spring member, and the number of components can be reduced as compared with the case in which each of the magnets 20 is pressed and supported by a pressing member, whereby the assembly of the motor core 1 is easily performed.

As described above, according to the motor core 1 of the embodiment, the magnets 20 can be assembled into the motor core main body 10 in a simple configuration by using the pressing body 30.

Hereinafter, some modification examples of the motor core 1 according to the above-described embodiment will be described.

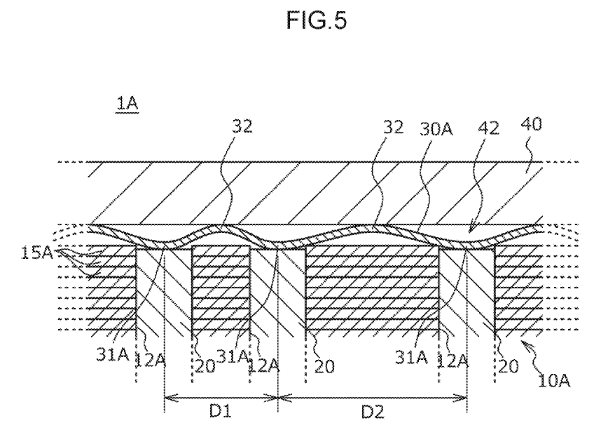

In the above-described embodiment, a case in which the adjacent valley portions 31 of the pressing body 30 are provided at equal intervals D is exemplified in relation to a state in which the slots 12 are formed at equal intervals in a circumferential direction, but the intervals D may be different from each other. Hereinafter, a modification example in which the valley portions 31 are not provided at regular intervals will be described with reference to FIG. 5. In a motor core 1A of a modification example illustrated in FIG. 5, the same components as those of the motor core 1 according to the above-described embodiment will be denoted by the same reference numerals and will not be described, and only differences from the motor core 1 according to the embodiment will be described.

FIG. 5 is a cross-sectional view of a motor core according to a modification example, the view corresponding to FIG. 3. In the motor core 1A according to the modification example, as illustrated in FIG. 5, a plurality of slots 12A of a motor core main body 10A including a plurality of core pieces 15A are not provided at equal intervals in a radial direction. Therefore, intervals at which valley portions 31A of a pressing body 30A of the motor core 1A of the modification example are provided are also adjusted depending on the positions of the slots 12A. Specifically, a gap D1 between the valley portions 31A corresponding to a location where a distance between the slots 12A is relatively short is adjusted to be shorter than a gap D2 between the valley portions 31A corresponding to a location where a distance between the slots 12A is relatively long. As described above, arrangement of the valley portions 31A of the pressing body 30 is adjusted, thereby enabling the assembly of the magnet 20 to be reliably performed.

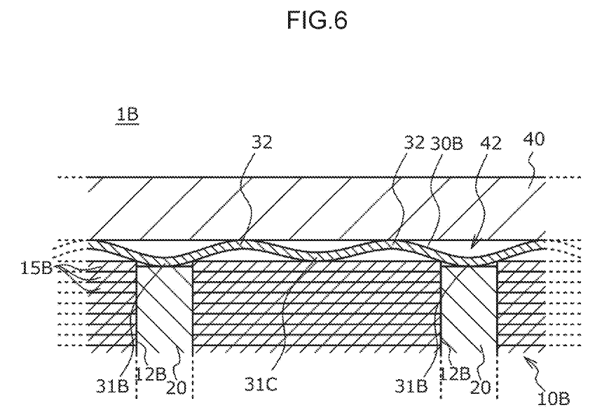

In the above-described embodiment, a case in which all the valley portions 31 abut on any of the end surfaces 21 of the plurality of magnets 20 is exemplified, but it is not absolutely necessary for all the valley portion 31 to abut on the end surfaces 21 of the plurality of magnets 20. Hereinafter, another modification example of the embodiment in which some of the valley portions do not abut on the plurality of magnets 20 will be described with reference to FIG. 6. In a motor core 1B of the modification example illustrated in FIG. 6, the same components as those of the motor core 1 according to the above-described embodiment will be denoted by the same reference numerals and will not be described, and only differences from the motor core 1 according to the embodiment will be described.

FIG. 6 is a cross-sectional view of the motor core according to the modification example, the view corresponding to FIG. 3. In the motor core 1B according to the modification example, as illustrated in FIG. 6, a plurality of slots 12B of a motor core main body 10B including a plurality of core pieces 15B are provided at intervals in a radial direction which are larger than the intervals in the above-described embodiment. A pressing body 30B of the motor core 1B of the modification example includes a valley portion 31B that abuts on the end surfaces 21 of the magnets 20 and a valley portion 31C that does not abut on the end surface 21 of the magnet 20. Among the valley portions, the valley portion 31C that does not abut on the end surface 21 of the magnet 20 abuts on an end surface of the motor core main body 10B, and this abutment causes the valley portion 31C to be pressed toward the peak portion 32, so that an effect of pushing the valley portion 31B that abuts on the end surface 21 of the magnet 20 against the end surface 21 of the magnet 20 can be obtained. This enables the end surface 21 of the magnet 20 and the valley portion 31B to more reliably abut on each other.

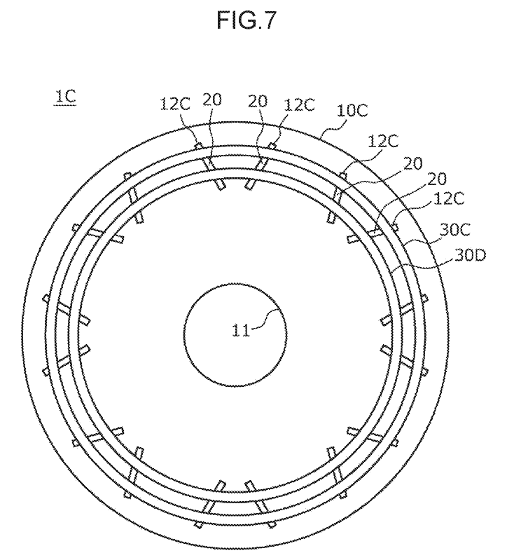

In the above-described embodiment, the pressing body including one spring member has been exemplified as the pressing body 30, but two or more spring members may be included. Still another modification example of the embodiment in which the pressing body includes two spring members will be described below with reference to FIG. 7. In a motor core 1C of the other modification example illustrated in FIG. 7, the same components as those of the motor core 1 according to the above-described embodiment will be denoted by the same reference numerals and will not be described, and only differences from the motor core 1 according to the embodiment will be described.

FIG. 7 is a plan view obtained by omitting a holding plate of a motor core according to the other modification example. In the motor core 1C according to the modification example, as illustrated in FIG. 7, slots 12C formed in a motor core main body 10C are arranged in an inclined shape at a predetermined angle with respect to a radiation direction with the central axis X of the motor core main body 10 as a reference. As illustrated in FIG. 7, as the pressing body in the modification example, a first pressing body 30C arranged to cross outer portions of the slots 12C and a second pressing body 30D arranged to cross inner portions of the slots 12C are coaxially arranged. The first pressing body 30C and the second pressing body 30D have different diameters, and the first pressing body 30C has a larger diameter than that of the second pressing body 30D. The first and second pressing bodies 30C and 30D can include the same spring member as that of the pressing body 30 described in the embodiment, and the arrangement of the valley portions and the peak portions and the extension direction of the ridge lines thereof can also be adjusted depending on the arrangement of the magnets 20 or the like, similarly to the pressing body 30 of the embodiment. According to the motor core 1C of the modification example, since the magnets 20 can be pressed and supported at a plurality of locations by using the plurality of pressing bodies 30C and 30D, an assembled state of the magnets 20 can be further stabilized.

The disclosure is not limited to the above-described embodiment, and various modifications can be made without departing from the gist of the disclosure. These modifications are all included in the technical idea of the disclosure. In the disclosure, the number of each of the components may be only one or two or more as long as the components are compatible.

All references, including publications, patent applications, and patents, cited herein are hereby incorporated by reference to the same extent as if each reference were individually and specifically indicated to be incorporated by reference and were set forth in its entirety herein.

The use of the terms "a" and "an" and "the" and similar referents in the context of describing the disclosure (especially in the context of the following claims) is to be construed to cover both the singular and the plural, unless otherwise indicated herein or clearly contradicted by context. The terms "comprising," "having," "including," and "containing" are to be construed as open-ended terms (i.e., meaning "including, but not limited to,") unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., "such as") provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A motor core comprising:
a motor core main body having a plurality of slots arranged circularly at predetermined intervals;
a plurality of magnets that are inserted into the plurality of slots;
a pressing body that supports, from at least one of end portions of the plurality of slots in a direction along a central axis of the motor core main body, the plurality of magnets inserted into the plurality of slots; and
holding plates attached to both end portions of the motor core main body along the central axis,
wherein the pressing body includes a spring member having an annular shape or a C shape in plan view in which valley portions uplifted in a direction toward the motor core main body and peak portions uplifted in a direction away from the motor core main body are alternately provided along a circumference around the central axis of the motor core main body, and at least one of the valley portions abuts on an end portion of each of the plurality of magnets when the pressing body is installed at at least one of the end portions of the motor core main body in the direction along the central axis.

2. The motor core according to claim 1, wherein at least one of a surface of the holding plate on a side adjacent to the motor core main body or a surface of the motor core main body with which the pressing body is brought into contact has an accommodation portion capable of accommodating the pressing body.

3. The motor core according to claim 1, wherein lengths of the plurality of magnets in the direction along the central axis in a case of being inserted into the plurality of slots are shorter than lengths of the plurality of slots in the direction along the central axis.

4. The motor core according to claim 1, wherein the pressing body includes a plurality of spring members adjusted to have different diameters.

5. The motor core according to claim 1, wherein at least one of the holding plate or the motor core main body includes a positioning portion that positions the pressing body.

6. The motor core according to claim 1, wherein all of the valley portions abut on the plurality of magnets accommodated in the plurality of slots.
